(19) United States
(12) Patent Application Publication
(10) Pub. No.: US 2007/0024705 A1
(43) Pub. Date: Feb. 1, 2007

(54) Systems and methods for video stream selection

(76) Inventors: Roger K. Richter, Leander, TX (US); Robert H. Brannon JR., Dripping Springs, TX (US); Jason C. Weaver, Austin, TX (US)

Correspondence Address: O'KEEFE, EGAN & PETERMAN, L.L.P., Building C, Suite 200, 1101 Capital of Texas Highway South, Austin, TX, 78746, US

(21) Appl. No.: 11/194,914

(22) Filed: Aug. 1, 2005

(51) Int. Cl. H04N 7/18; G06F 3/00; H04N 9/47; G06F 13/00; H04N 5/445

(52) U.S. Cl. 348/142; 725/38; 348/143

(57) ABSTRACT

Systems and methods for selecting reception of video streams in an adaptive fashion, for example, from a multi-stream video source. In one implementation, reception of the video streams may be dynamically switched such that optimal bandwidth is selected in adaptive fashion using a set of video parameters, such as the size or dimensions of the viewing window, and/or a set of system and network parameters, to ascertain the optimal stream selection.

### FIELD OF THE INVENTION

This invention relates generally to video streaming, and more particularly to the delivery of video streams.

### BACKGROUND OF THE INVENTION

Current video streaming technology is primarily based on the design point of delivering fixed resolution and/or fixed-rate video streams for consumption by client software. In practice, this is typically accomplished using a video source (usually a camera) providing a single video stream, a video access component (usually a video stream server) providing a single video stream to a client, and client viewing software that operates on a Personal Computer (PC) with an intervening network that is used to transfer the video stream(s) and the associated control connections. Using such technology, it is possible that the video camera and stream server components may be one device.

In practice, a video source device and stream server provide a stream of a fixed resolution (e.g., 640 H×480V) at a predetermined frame and/or bit rate (e.g., 30 frames/second). This poses a significant set of problems for viewing client software due to the fact that fixed resolution and rate video sources, whether live or stored, typically do not match well with the bandwidth availability of the intervening transit network and, in some cases, the limitations of local computer resources (processing power, memory availability, etc.). In the case where the video source/s is higher resolution (greater than or equal to VGA quality), there is a low likelihood that the video stream/s may be satisfactorily viewed due to the fact that the bandwidth involved is in the 2.5 Mbps throughput range or greater. For example, a live or prerecorded video stream from a 1 Megapixel video source at 30 fps (full motion) is in the 4 Mbps range. This poses a significant problem from both a bandwidth and compute perspective since continuous bandwidth availability of most current transit networks is about 3 Mbps, and processing resources of a typical PC-based client viewing system is limited to about 640 H×480V at 30 fps while not performing other PC-related actions. This problem is exacerbated in environments where the viewer either needs or desires to view multiple video sources simultaneously, which is a common practice in the Surveillance/CCTV industry.

As an example, assume a Windows-based PC viewing client desires to simultaneously watch six camera sources across a network. Each camera source has a traditional resolution of 640 H×480V and produces a video stream at a frame rate of 30 frames/second (fps). Currently, this video stream would have a bitrate ranging from 2 Mbps to 20 Mbps due to the various video compression types. Assume for this example that a stream rate of 3 Mbps is chosen. For a PC to watch six camera sources via 3 Mbps streams consisting of 640 H×480V 30 fps video is roughly the equivalent of trying to play six conventional digital video disks (DVDs) simultaneously. Therefore, there is a significant compute burden, and Input/Output (I/O) processing burden, associated with each stream.

To enable the viewing client to simultaneously watch the six camera sources using conventional video streaming technology, it is possible to reduce the resolution (horizontal & vertical dimensions) of the video images, reduce the frame rate of the video stream, and/or to increase the compression factor used to compress the video stream into a lower bitrate. However, all of the above options diminish the observed video quality. Furthermore, increasing the compression factor does not diminish the compute burden associated with a video stream (i.e., it might alleviate network bandwidth issues but the compute issues are still present).

Compute problems are further exacerbated by the fact that the viewing space available on a typical conventional viewing client screen (monitor, LCD, etc.) does not change with respect to the characteristics of the incoming video stream, but with respect to the viewing operations being performed by the user. In short, the more cameras/scenes simultaneously viewed by a client, the smaller the dimensions of the viewing ‘window’ for that scene. For example, assuming that there is a 1024 H×768V viewing space at the client, six equally-sized simultaneous views would each occupy an individual window space of 170 H×128V viewing. Similarly, four equally-sized views would each occupy a 256 H×192V window, and eight equally-sized views would each occupy a 128 H×96V window each. However, the resolution of such viewing windows on the client application do not match the native, or incoming, resolutions from each common camera/video source. This resolution mismatch between source and viewing client requires client applications to scale incoming video streams into the desired viewing window, many times at undesirable scaling factors, which consumes more compute and memory bandwidth, and produces video quality issues that are the resultant side-effects from scaling.

Problems become more complex when the camera/video source is factored into this scenario. To provide better bandwidth and compute management, many users configure their conventional cameras/video sources to generate video in one of two basic categories: A) better resolution at lower frame rates (e.g. 640 H×480V @ 5 fps), or B) lower resolutions at higher frame rates (e.g. 320 H×240V @ 15 fps). These categories represent the trade-offs forced upon the user trying to obtain ‘useable’ video from multiple simultaneous sources that have fixed video stream characteristics.

In the past, a separate co-processor has been employed to enable viewing of a single high bandwidth high resolution stream, however, this implementation requires additional client processing hardware expense.

### SUMMARY OF THE INVENTION

Systems and methods for selecting reception of video streams in an adaptive and, in one embodiment, dynamic fashion, for example, from a multi-stream video source. In one embodiment, reception of the video streams may be dynamically switched such that optimal bandwidth is selected in adaptive fashion using a set of video parameters, such as the size or dimensions of the viewing window, and environmental related parameters, such as bandwidth and processing resource usage, to ascertain the optimal stream selection. In another embodiment, a video stream of an image may be selected for viewing that is adapted to the needs of a user while at the same time maximizing efficiency of system resource usage, e.g., by adaptively selecting a video stream that meets the minimum resolution required by a user for a given viewing situation (and no more) to increase response time, reduce bandwidth requirements, and to reduce scaling artifacts.

The disclosed systems and methods may be beneficially implemented for surveillance applications or, for example, for other types of video viewing applications such as in situations where multiple video sources (e.g., video cameras) are viewed simultaneously or in situations where a user is allowed to dynamically resize a viewing window on a display device. In this regard, the disclosed systems and methods may be implemented to enable optimized simultaneous viewing of multiple video sources for each individual viewing client. This is in contrast to conventional video viewing systems in which the cumulative effect of viewing multiple scenes simultaneously produces an inordinate bandwidth and compute burden for the viewing client and the connected network, especially as the resolution of a camera source is increased. In such conventional systems, the video source is fixed (i.e., the frame rate and resolution cannot be modified), and a viewing client is incapable of adapting the video source to its environmental constraints. In this regard, the adaptation of a video stream of fixed attributes into an arbitrary viewing space (window) is a scenario that does not provide the proper balance between computer and network resources versus viewing quality and operation. Furthermore, standard single-stream camera sources, such as those employed in the Surveillance industry, are designed such that a configuration change for any of the above parameters affects all viewers irrespective of client viewing capabilities or network capacity (i.e., the behavior is static at the source).

In the practice of the disclosed systems and methods, a video delivery system may be provided that includes one or more video source components in combination with one or more client viewing applications. In such an embodiment, a video source component may be configured to produce video streams of multiple different combinations of rates and resolutions (e.g., two or more different combinations of rates and resolutions, three or more different combinations of rates and resolutions, etc.), and a client viewing application may be configured to understand the multi-stream capabilities of the aforementioned video source component. A client viewing application may be further configured in one embodiment to analyze its own viewing operations and to dynamically select the optimal video stream type/rate based on the results of the analysis. Such an analysis by the viewing client may be based on one or more stream selection parameters including, but not limited to, attributes (e.g., bitrate, frame rate, resolution, etc.) of video streams available from a video source, local viewing window resolution for the associated video stream, the number of input video streams in combination with the number of active views, computer resource status (e.g., memory availability, compute load, etc.), network bandwidth load, resource status of the video source, one or more configured policies regarding viewing operations, combinations thereof, etc.

In one embodiment, disclosed herein is an interactive video delivery system that includes a video source and/or video source and/or coupled video access component that provides multiple (greater than one) video streams of a given scene, and an intelligent viewing client that analyzes viewing operations and/or viewing modes and dynamically selects the optimal video stream/s provided by the video source in a manner that provides optimized (e.g., optimal) bandwidth and compute utilization while maintaining the appropriate video fidelity. In such an embodiment the video source, and/or a video access component coupled thereto, may be configured to advertise (e.g., using either standard or proprietary methods) information concerning the rates and resolutions of the available video streams related to a given scene/source (camera, etc.). The viewing client may be configured to select an optimized stream rate/s (e.g., optimal stream rate/s) for viewing the video data based at least in part on the information advertised by the video source and/or video access component. The viewing client may also be configured to perform this selection based further in part on one or more viewing operations selected by the user and/or by configuration. In another embodiment, a viewing client may also be configured to select an optimized stream frame rate and/or resolution by performing an analysis in which it selects the optimal stream rate/s and/or resolutions in an adaptive fashion (i.e., adapted to current video delivery operating conditions and/or currently specified video modes) for viewing the video data. This adaptive selection process may advantageously be performed in a dynamic, real-time manner.

In one respect, disclosed herein is a video selection system, including at least one viewing client configured to be coupled to receive at least two video streams over at least one network connection, and in which the viewing client is configured to select at least one of the video streams based at least in part on at least one video stream selection parameter.

In another respect, disclosed herein is a video selection system including a viewing client configured to be coupled to receive at least two video streams over at least one network connection, and in which the viewing client is configured to adaptively select at least one of the video streams based at least in part on at least one of current video delivery operating conditions, current specified viewing display modes, or a combination thereof.

In another respect, disclosed herein is a method of selecting video streams, including selecting at least one video stream from at least two video streams available over at least one network connection, in which the at least one video stream is selected from the at least two video streams based at least in part on at least one video stream selection parameter.

In another respect, disclosed herein is a method of selecting video streams, including adaptively selecting at least one video stream from at least two video streams available over at least one network connection, in which the at least one video stream is selected from the at least two video streams based at least in part on at least one of current video delivery operating conditions, current specified viewing display modes, or a combination thereof.

In another respect, disclosed herein is a video delivery system, including: one or more video source components, the one or more video source components being configured to provide at least two video streams; at least one video display component; and a viewing client coupled to receive the at least two video streams over at least one network connection, the viewing client being coupled to the video display component. The viewing client may be configured to select at least one of the at least two video streams based at least in part on at least one video stream selection parameter, and to provide the at least one selected video stream to the video display component for display.

In another respect, disclosed herein is a video delivery system, including: at least one video access component coupled to receive at least one video stream from at least one video source component; at least one video display component; and a viewing client coupled to receive at least two video streams over at least one network connection, at least one of the at least two video streams received by the viewing client being received from the at least one video access component, and the viewing client being coupled to the video display component. The viewing client may be configured to select at least one of the at least two video streams received by the viewing client based at least in part on at least one video stream selection parameter, and to provide the at least one selected video stream to the video display component for display.

In another respect, disclosed herein is a method of delivering video streams, including: providing at least two video streams over at least one network connection; selecting at least one of the at least two video streams based at least in part on at least one video stream selection parameter; and displaying the at least one selected video stream.

### BRIEF DESCRIPTION OF THE DRAWINGS

FIG. 1 is a simplified block diagram of a video delivery system according to one embodiment of the disclosed systems and methods.

FIG. 2 is a simplified block diagram of a video delivery system according to one embodiment of the disclosed systems and methods.

FIG. 3 is a simplified block diagram of a video delivery system according to one embodiment of the disclosed systems and methods.

FIG. 4 is a flow chart of video stream selection methodology according to one embodiment of the disclosed systems and methods.

### DESCRIPTION OF ILLUSTRATIVE EMBODIMENTS

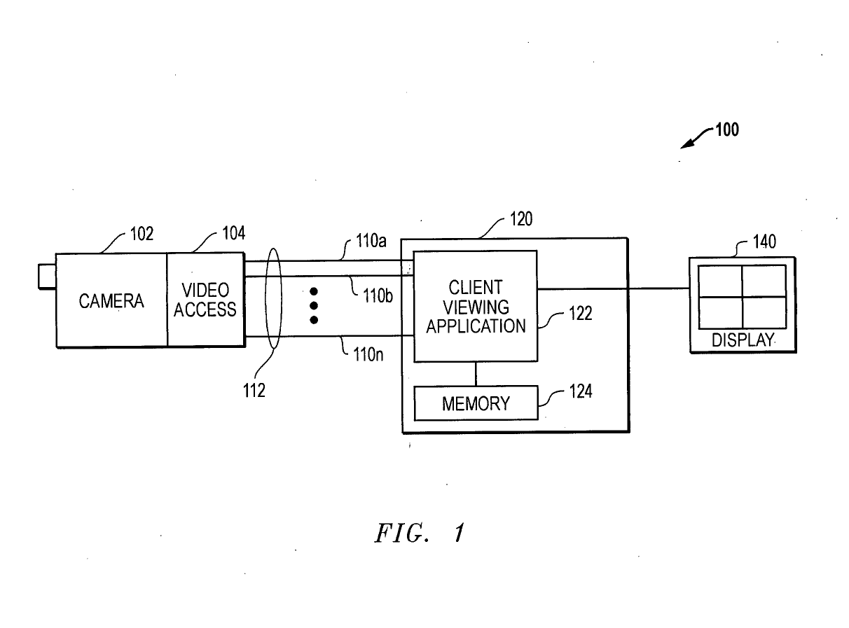

FIG. 1 shows a simplified block diagram of a video delivery system 100 as it may be configured according to one embodiment of the disclosed systems and methods. In this exemplary embodiment, video delivery system 100 includes a video source component or video source device (VSD) 102, a video access component 104, a viewing client 120, and a video display component 140. With regard to this and other embodiments described herein, it will be understood that the various video delivery system components may be coupled together to communicate in a manner as described herein using any suitable wired or wireless signal communication methodology, or using any combination of wired and wireless signal communication methodologies. Therefore, for example, network connections utilized in the practice of the disclosed systems and methods may be suitably implemented using wired network connection technologies, wireless network connection technologies, or a combination thereof.

As shown in FIG. 1, video source component 102 and video access component 104 are integrated together in this exemplary embodiment as a single device, although this is not necessary. In the embodiment of FIG. 1, video source device 102 and video access component 104 may be further characterized as being “closely coupled”, e.g., image hardware components of video source device 102 may be directly coupled to provide digital signals to integrated video access component circuitry of video access component 104 via bus, high speed serial link, etc.

In the exemplary embodiment of FIG. 1, video source 102 is a digital video camera and video access component 104 is a digital video stream server, however it will be understood that in other embodiments a video source may be any other type of device (e.g., analog video camera, digital video recorder, digital video tape deck, streaming media server, video-on-demand server, etc.) that is suitable for producing one or more digital or analog video streams. Furthermore, a video access component may be any device (e.g., digital video encoder, analog-to-digital encoder, analog-to-digital video recorder proxy streaming server/cache, etc.) that is suitable for receiving analog and/or digital video stream information from one or more video sources, and for generating or otherwise providing a single digital video stream, or for providing multiple digital video streams (e.g., of different rates and/or resolutions), that are based on the received video stream information and communicating these digital video stream/s across a computer network medium (e.g., via packet-based network, serial network, etc.). It will also be understood that a separate signal conversion component may be present to convert an analog video stream received from an analog video source to a digital video stream for communication across a computer network medium.

A video access component may be configured, for example, to perform advertisement of stream attributes, to perform session management tasks, and to implement video stream protocols. In this regard, examples of video access components include, for example, devices that take analog input signals and convert them to digital formats and which may also encode signals using any suitable format/protocol (e.g., known video compression format/protocol), as well as devices of any configuration that are capable of converting/transcoding (e.g., frame rate adaptation and/or scaling) or forwarding video streams.

It will be understood that a video access component need not be present between a given video source/s and a viewing client, i.e., one or more video streams may be provided from a video source to a viewing client over one or more network connections in any alternative suitable manner. Therefore, for purposes of this disclosure, a video stream/s may be considered to be provided from a video source and received by a viewing client from the video source over one or more network connections whether or not the video stream/s is transferred from the video source/s to the viewing client through a video access component. Furthermore, the session management functions of a video access component may be logically implemented in any suitable configuration, whether it is as a stand alone device or system, integrated component of another device or system, or implemented by more than one device or system.

Still referring to FIG. 1, video access component 104 is coupled to communicate multiple digital video streams 110a to 110n across computer network medium 112, to a viewing client 120. Network medium 112 may be a packet-based network (e.g., TCP/UDP/IP, IPX/SPX, X.25, etc.), or a serial network (e.g., ISDN, DS0/DS1/DS3, SONET, ATM, etc.). Each of multiple video streams 110 may represent, for example, a different combination of video rate and video resolution of a single scene that is captured by video source 102 and provided to video access component 104, which performs the video streaming and session management functions for video source 102. For example, video source 102 may be a multi-stream (e.g., dual rate) digital video camera, or may be a digital video camera that includes encoders for providing three or more digital video input streams to video access component 104 for delivery across network medium 112 in the form of protocol compliant video streams 110. As shown, viewing client 120 is in turn configured to provide video image data based on video streams 110 to video display component 140, e.g., as multiple windows for viewing by a user on video display component 140. In the illustrated embodiment, viewing client 120 includes client viewing application (CVAP) 122 executing on viewing client 120, and coupled to optional memory 124. It will be understood that viewing client 120 may include any combination of hardware and/or software suitable for performing one or more tasks described elsewhere herein, e.g., one or more central processing units (CPUs) or microprocessors and optional memory configured to execute one or more tasks of client viewing application 122 as they will be described further herein. In one exemplary embodiment, viewing client 120 may be a PC-based workstation coupled as network node to network 112, and video display component 140 may be a computer monitor coupled to the PC-based workstation.

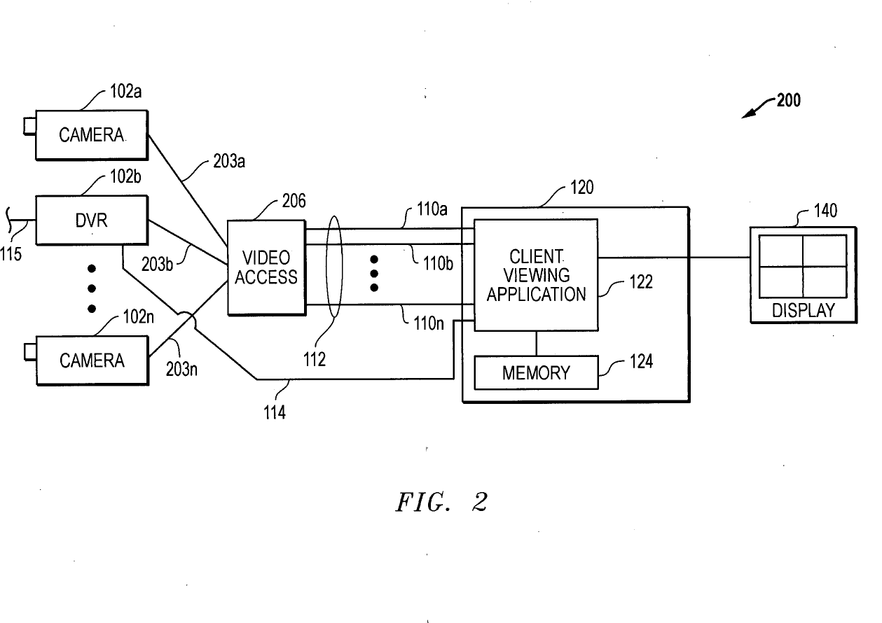

FIG. 2 shows a simplified block diagram of a video delivery system 200 as it may be configured according to another embodiment of the disclosed systems and methods. In this exemplary embodiment, video delivery system 200 includes multiple separate video source components 102a through 102n that are each coupled to deliver one or more analog video streams (e.g., as one or more standard composite video streams) to video access component 206 via a respective dedicated analog signal connection 203a through 203n, as shown. In this exemplary embodiment, video sources 102a and 102n are each analog video cameras, and video source 102b is a digital video recorder (DVR) having an analog signal output (e.g., analog video output loop) coupled to provide an analog video signal over dedicated connection 203b to video access component 206. As shown in FIG. 1, DVR video source 102b may also be optionally coupled to receive analog video input signals 115.

In the embodiment of FIG. 2, video access component 206 contains processing logic to convert the analog video signals 203 into digital video data and scale and encode these input streams into multiple digital video output streams 110. As shown in FIG. 2, it is also possible that digital video data stored in DVR 102b may be optionally provided directly (e.g., bypassing video access component 206) to viewing client 120 in its recorded format using optional network medium communication path 114 e.g., via a video access component integrated within DVR 102b. In this regard, optional network medium 114 may be a separate network connection coupled to viewing client 120 as shown, or may be a network connection that is coupled to provide digital video data to viewing client 120 via network medium 112 (e.g., via shared Ethernet, etc.)

In an alternatively embodiment, multiple separate video source components 102a through 102n may be each coupled to deliver one or more digital video streams to video access component 206 via a computer network (not shown). In such an alternative embodiment, video source 102b may be a DVR that is configured to record and playback digital video data received from one or more other video sources 102 through such a computer network that links video source components 102a through 102n to video access component 206.

As shown in FIG. 2, video access component 206 is coupled to communicate multiple digital video streams 110a to 110n across computer network medium 112 to viewing client 120. Each of multiple video streams 110 may represent, for example, video data provided by one of video sources 102a through 102n at a specific combination of video rate and video resolution. In this exemplary embodiment, it is possible that each of video streams 110 include video data provided by a different video source 102, or that at least two of video streams 110 may include video data provided by the same video source 102, but at a different combination of video rate and video resolution. As shown, viewing client 120 is in turn configured to provide video image data based on video streams 110 to video display component 140 in a manner as previously described.

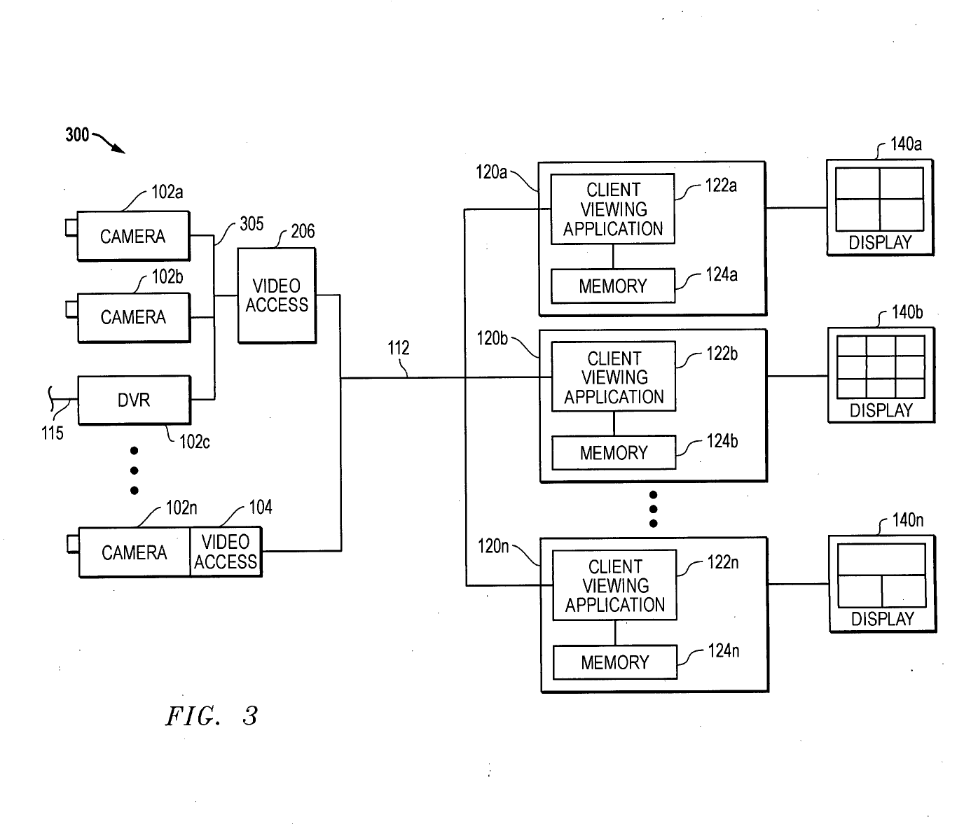

FIG. 3 shows a simplified block diagram of a video delivery system 300 as it may be configured according to yet another embodiment of the disclosed systems and methods. In this exemplary embodiment, video delivery system 300 includes multiple separate video source components 102a through 102n. As shown, video source components 102a, 102b, and 102c (DVR) are each coupled to deliver one or more digital video streams to video access component 206 via a computer network 305. Further, DVR video source 102c may also be optionally coupled to receive analog video input signals 115, and any given one or more of multiple separate video source components 102a through 102c may optionally include an integrated video access component.

In the embodiment of FIG. 3, video source devices 102 and video access component 104 may be further characterized as being “loosely coupled”, e.g., image hardware components of video source devices 102 may be coupled to provide digital signals to video access component circuitry of video access component 104 via computer network medium. In such a case, digital signals provided by video source devices 102 to video access component 104 may be encoded using suitable compression protocol (e.g., MPEG-2, MPEG-4, H.263, H.264, etc.). It will be understood that FIG. 3 is exemplary only, and that video source components 102 may be coupled to provide one or more video streams to video access component 206 using any suitable method, e.g., switched or shared network connection, dedicated connections, etc.

Video access component 206 is configured to receive the input video streams on network medium 305, scale and/or transcode these streams into various rate and resolution video streams, and, is in turn coupled to communicate these multiple digital video streams (not shown separately in FIG. 3) across computer network medium 112 to multiple viewing clients 120a through 120n, each of which is in turn configured to provide video image data based on the video streams to a respective video display component 140a through 140n. The DVR 102c, for example, may provide one or more video streams representing pre-recorded video data obtained from one or more other video sources (not shown) to video access component 206, in addition to ‘live’ video streams. As shown in FIG. 3, each of viewing clients 120a through 120n is configured as previously described and includes a respective client viewing application 122 and optional memory 124. As further shown in FIG. 3, video delivery system 300 includes at least one additional video source component 102n that is coupled via an integrated video access component 104 to computer network medium 112.

It will be understood that a video access component may be optionally configured in one embodiment to receive at least one first video stream, to decompose (e.g., decode) the first video stream, and to perform scaling and/or rate adaptation tasks on the first video stream in order to provide at least one second video stream that is based on the first received video stream. In such an embodiment, the first video stream may have a first combination of resolution and frame rate, the second video stream may have a second combination of resolution and frame rate, and the first combination of resolution and frame rate may be different than the second combination of resolution and frame rate (i.e., the resolution of the first combination is different then the resolution of the second combination, the frame rate of the first combination is different than the frame rate of the second combination, or both). Therefore, it is possible in one exemplary embodiment that that a single video access component may provide to a viewing client at least two different video streams that are based on a single video stream provided by a single video source to the video access component. Alternatively a single video access component may provide to a viewing client a single video stream that is based on a single video stream provided by a single video source to the video access component. Such a single video stream may be provided to a network with other video streams, e.g., provided by other video source/s and/or video access component/s. In one embodiment, a given video access component may advertise stream attributes of video streams provided by other video access comments to the same network, e.g., in a situation where different video streams of the same scene/image are provided by different video access components.

In each of the embodiments of FIGS. 1 to 3, client viewing application 122 may be configured to select the identity of at least one received video stream 110 for display based at least in part on one or more stream selection parameters. In one embodiment, a stream selection parameter may be a dynamic parameter (i.e., a parameter subject to change during system operations), and client viewing application 122 may adapt to changing system operating conditions by monitoring one or more of such dynamic stream selection parameters that reflect these changing conditions. Such a dynamic parameter may be based, for example, on one or more characteristics of an available video stream/s 110, based on one or more characteristics of a given viewing system hardware and/or software configuration (e.g., video display component 140 usage, processor or memory usage of viewing client 120, user operations on video client 120, etc.), based on requirements of a particular viewing application, etc. Specific examples of dynamic stream selection parameters include, but are not limited to, attributes (e.g., bitrate, frame rate, resolution, etc.) of video stream/s 110 currently available from a video source/s, available current local viewing window resolution of video display component 140 for a given associated video stream 110, the current number of input video streams 110 in combination with the current number of active views on display component 140, current resource status (e.g., memory availability, compute load, etc.) of viewing client 120, current bandwidth load of network 112, current resource status (e.g., compute load, memory availability, concurrent number of active video sessions/streams, etc.) of the video source/s 102, etc.

A stream selection parameter may also be a static parameter such as a parameter based on one or more fixed characteristics (e.g., video display component 140 capability, processor or memory capabilities of viewing client 120, etc.) of a given viewing system hardware and/or software configuration, or a user-specified or pre-programmed default policy parameter, etc. Specific examples of static stream selection parameters include, but are not limited to, maximum local viewing window resolution of video display component 140, maximum resource capability (e.g., total memory, total compute capability, etc.) of viewing client 120, maximum bandwidth capability of network 112, maximum resource capability of the video source/s 102, one or more configured policies, maximum number of active video streams allowed at video client 120, maximum bandwidth allowed to be processed by video client 120, etc.

In one exemplary embodiment a static stream selection parameter may be a configured or pre-programmed static stream selection policy that acts to constrain one or more operating characteristics of a video delivery system. One example type of static stream selection policy is a policy that specifies maximum allowable total video stream bandwidth (i.e., total bandwidth of all selected video streams) to be delivered over network 112 to a viewing client 120 at any given time. Another example type of static stream selection policy is a policy that specifies maximum allowable processor (compute) resource usage of viewing client 120 for a given combination of selected video streams displayed on a video display component 140. For example, a stream selection policy may specify a maximum allowable processor usage of about 50% for a four window Standard Interchange Format (SIF)-15 display (e.g., four 352 H by 240V pixel windows displayed at 15 frames per second) on video display component 140 as shown in FIG. 1.

Another example type of static stream selection policy is a policy that specifies selected video stream resolutions for a given viewing mode, i.e., the given configuration of one or more video windows of given spatial resolution to be displayed on video display component 140. In this regard, a policy may specify that video stream resolution/s be selected to match specified spatial resolution/s of one or more display windows to be provided for display. For example, a static stream selection policy may specify that nine equally-sized windows always be displayed at SIF-15 (e.g., nine 352 H×240V rectangular pixel or 320 H×240V square pixel windows displayed at 15 frames per second) on video display component 140b in FIG. 3. In yet another example, a static stream selection policy may specify that sixteen equally-sized windows always be displayed at Quarter Standard Interchange Format (QSIF)-15 (e.g., sixteen 176 H by 120V rectangular pixel or 160 H×120V square pixel windows at 15 frames per second) on a video display component 140 (not shown). In this regard, network bandwidth for displaying any such combination of video streams is determined by the resolution of the video streams selected for display, such a policy may be implemented, for example, as a way to control total network bandwidth required to display the video streams.

In another example, a static stream selection policy may be implemented to help reduce video artifacts by specifying that client viewing application 122 always scale down a video stream (rather than scale up the video stream) to fit available window space on video display component 140. In this regard, given an available window area of 240 H×180V square pixels in combination with a video stream having a SIF of 320 H×240V square pixels (QSIF of 160 H×120V square pixels), a static stream selection policy may specify that client viewing application 122 always scale the video stream down to fit the available window area. In yet another example, a static stream selection policy may specify that client viewing application 122 always select lower video resolutions for relatively smaller-sized display windows in order to save bandwidth of network 112.

It will be understood that the preceding static stream selection policies are exemplary only, and that other policies and/or combinations of such policies may be implemented. For example, another type of stream selection policy may specify that the highest frame rate available video stream/s always be selected that may be displayed (regardless of resolution) without exceeding compute resources or network bandwidth capacity of the viewing client component. Such a policy may be desirable where fast frame rate is more important than resolution, e.g., such as in a casino surveillance operation where detection of quick movements is important. Alternatively, a stream selection policy may specify that the optimal or highest resolution available video stream/s always be selected that may be displayed (regardless of frame rate) without exceeding compute resource or network bandwidth capacity, e.g., in a situation where detection of fine details is more important than detecting quick movement. In another example, a static stream selection policy may specify that the lowest resolution available video stream/s always be selected or that the lowest frame rate available video stream/s is always selected, regardless of compute resource or network bandwidth capacity. Such policies may be desirable, for example, where preserving network bandwidth and/or computer resource capacity is most important.

In one embodiment of the practice of the disclosed systems and methods, stream selection parameters may be processed by client viewing application 122 in a manner that optimizes video quality relative to system operating efficiency, or vice-versa. In this regard, a stream selection policy may be implemented that specifies that video quality (e.g., resolution, frame rate, etc.) always be maximized at the expense of system operating efficiency (e.g., network bandwidth, compute resource usage, etc.). Alternatively, a stream selection policy may be implemented that specifies that system operating efficiency always be maximized at the expense of video quality. In yet other examples, a stream selection policy may trade-off or balance between video quality and system operating efficiency under particular conditions.

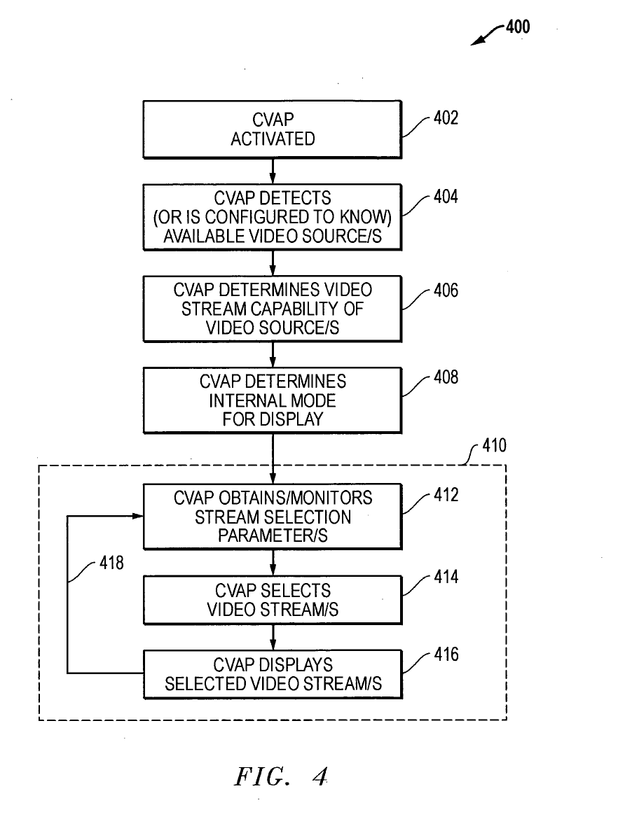

FIG. 4 is a flow chart illustrating one exemplary embodiment of video stream selection methodology 400 that may be implemented using the disclosed systems and methods, for example, in conjunction with a video display system 100, 200 or 300 of FIG. 1, 2 or 3, respectively. Video stream selection methodology 400 begins in step 402 with activation of CVAP 122. Upon activation, CVAP 122 either detects the identity of available video source/s 102 (e.g., via Service Location Protocol (SLPv2 RFC 2608) or LDAP or UPnP, etc.), or may be configured to know the identity of available video source/s 102 in step 404 (e.g., by directly entering a fixed network domain name or IP address). Next, in step 406, CVAP 122 determines the video stream capability (i.e., via Session Description Protocol (SDP, RFC 2327) or Session Initiation Protocol (SIP, RFC 2543) or H.245, etc.) of the video source/s 102 identified in step 404. CVAP 122 may determine the video steam capability of the video source/s 102 in any suitable manner, for example, by querying video source/s 102 for video stream information (e.g., using RTSP/SDP, etc.) and/or receiving video stream information advertised by video source/s 102 (e.g., using SLP, H.225/H.245, etc.) and/or video access components 104 or 206 in a manner similar to that described below in relation to obtaining stream selection parameters in step 412.

Following determination of video source/s identity and video steam capability in steps 404 and 406, CVAP 122 may determine internal viewing mode for display component 140 (i.e., based on the client viewing application's feature set and viewing capabilities) in step 408. Examples of internal viewing mode information include, but are not limited to, the types of screen layouts available for viewing, the decoding and screen rendering capabilities of the application and its hardware, the types of viewing functions supported by the client viewing application, video window attributes, the presence of video graphics hardware that offloads buffering and video scaling, operating system type/version information, available system memory, hardware display type and attributes (spatial resolution, aspect ratio, color resolution), etc. In this regard, internal viewing mode information may be obtained by CVAP 122, for example, by reading application specific configuration information from an operating system registry or from a file, by retrieving system policy information, regarding allowable functions and operation from a network attached server, etc.

Following steps 402 through 408, CVAP 122 may execute video stream selection and display logic 410, in this exemplary embodiment by implementing steps 412 through 416. As shown in FIG. 4, CVAP 122 may obtain and monitor video stream selection parameter information in step 412. In one embodiment, this video stream selection parameter information may include one or more attributes of video streams available from the video source/s 102 identified in step 406. In this regard, CVAP 122 may obtain and monitor video stream selection parameter information from video source/s 102 in any suitable manner. For example, CVAP 122 may query an identified video source/s 102 for stream selection parameters using, for example, Real Time Streaming Protocol/Session Description Protocol (RTSP/SDP) or any other suitable querying protocol. In response, the queried video source/s 102 may respond with attribute information (e.g., video rates and resolution information including bit rate, frame rate and video stream resolution) concerning digital video streams 110 available from the queried video source 102. Alternatively, a given digital video source 102 and/or video access component 104 or 206 may advertise attributes of available digital video streams to CVAP 122, e.g., using Service Location Protocol (SLP), H.225, or any other suitable protocol. In either case, a single digital video source 102 may indicate to CVAP 122 that it is providing one or more digital video streams of given rate and/or resolution. For example, a video source may indicate to CVAP 122 in step 412 that it is capable of providing a first digital video stream 110a (15 frame per second, 300 kB stream) of a given image, and a second digital video stream 10b (5 frame per second, 100 kB stream) of the same given image. It will be understood that video stream attributes may be advertised multiple times (e.g., updated) during a given session, or may be advertised only once at the beginning of a given session. In either case, a digital video source and/or video access component may respond to a request for a given advertised video stream by indicating that the video stream is currently unavailable or that the video stream attribute/s have changed.

CVAP 122 may also obtain video selection parameters from sources other than video sources 122 in step 412. Such other video selection parameters include, but are not limited to, those parameters previously mentioned. For example, information concerning local viewing window resolution of video display component 140 for a given video stream 110 may be obtained by reading/querying parameters associated with the dimensions and aspect ratio of each individual viewing window. The number of active views being displayed on video display component 140 may be obtained, for example, by reading/querying screen layout/geometry parameters that indicate the number of, location of, and type of video windows per screen layout along with associated input stream parameters. Video display processor resource status (e.g., memory availability, compute load, etc.) of viewing client 120 may be obtained, for example, by querying operating system functions that provide CPU and memory utilization information or by using internal processing statistics. Bandwidth load of network 112 may be obtained, for example, by querying/reading network layer statistics or by analyzing data available in the video transport protocols that indicate latencies and data/packet loss or by analyzing I/O (interrupt, scheduling, and event) rates within the system. Resource status of video source/s 102 may be obtained, for example, by querying/reading statistics from video source/s 102 or from receiving periodic real-time status updates from video source/s 102.

In addition, one or more configured video selection policies may be obtained, for example, by reading configured policy information from a system registry or file, or by mapping specific screen layouts to specific policy parameters that govern video selection criteria. As will be described further herein, such video selection policies may be, for example, any user-specified or system default rule that may be employed in combination with one or more other video selection parameters to govern the selection of particular available video streams 110 for display on video display component 140.

Next, in step 414, CVAP 122 selects particular video stream/s from the available video streams determined in step 412, e.g., based on one or more stream selection parameters obtained in step 412. This selection process may be performed using any suitable analytical or computational logic (e.g., state machine logic, if-then-else logic, switch-case statement logic, real-time computation or analytical logic, lookup table logic, etc.). In step 416, CVAP 122 then displays the selected video stream/s on video display component 140 in accordance with internal viewing display modes determined in step 408. Video stream selection and display logic 410 may then continue by repeating steps 412 through 416 during the video delivery process, as indicated by arrow 418. As described elsewhere herein, CVAP 122 may analyze a variety of dynamic stream selection parameters (e.g., parameters related to system, network, and resource states), alone or in various combinations, to determine the optimal viewing stream selected for a given video display mode. It is also possible that configuration data regarding limits, modes, etc., may also be factored into any analysis performed. In one example dynamic adaptation to changing conditions may be achieved, e.g., for a given resolution of a single viewing mode, the frame rate may be changed upon detection of a change in computer resource load or network traffic. For example, the frame rate may be dropped as necessary to maintain a given resolution upon an increase in compute resource load or increase in network bandwidth load.

As described above, state machine logic is one type of logic that may be employed in the practice of video stream selection methodology according to the disclosed systems and methods. The use of state machine logic to define the logic flow for each viewing mode is not necessary, but may be implemented in a manner that is very efficient and flexible with respect to the ability to easily add per-state/substate logic in order to handle any additional parameter analysis (i.e., memory availability, network load, I/O rates, response times, etc.) that may be deemed necessary. In this regard, state machine logic may implemented in a manner that simplifies stream selection logic by forcing the selected active, incoming video stream type to be conditionally or directly associated with default window size of each specific viewing mode, e.g., as a static association performed within each viewing mode. Thus, any user operations resulting in a change in viewing modes dynamically triggers viewing stream re-analysis. However, in other embodiments, logic that counts the number of active display windows rather than analyzing states, or that simply analyzes compute resource loading, for example, may be alternatively employed.

In one embodiment, a state machine logic approach may be based on the current viewing mode in order to simplify the analysis and processing logic while providing flexibility for more static (pre-programmed, configuration driven) or more dynamic (complex parameter analysis) driven analysis modes. In one example of such an embodiment, each of the logic paths of the state machine may be configured to always attempt to display the video stream that most closely matches the geometric dimensions of the corresponding display window in order to reduce local compute loads and network bandwidth demands, while providing the highest-quality viewing experience by minimizing, or obviating, the need to scale a video stream into the target viewing window's display dimensions.

Table 1 illustrates exemplary client viewing modes that may be obtained from, for example, basic application configuration information and/or derived by analyzing the display capabilities of a system. As previously described, CVAP 122 may determine the client viewing modes in step 408 of FIG. 4.

TABLE 1

| | WINDOW SIZE/ | |
|---|---|---|
| VIEW MODE NAME | WINDOW COUNT | DESCRIPTION |
| SingleView/Big Mode | 1280 H × 960 V/1 Window | Single large viewing |
| | | window |
| 4-Way Grid | 640 H × 480 V/4 Windows | 2 × 2 Grid of 640 H × 480 V |
| | | viewing windows |
| 9-way Grid | 426 H × 320 V/9 Windows | 3 × 3 Grid of 426 H × 320 V |
| | | viewing windows |
| 16-way Grid | 320 H × 240 V/16 Windows | 4 × 4 Grid of 320 H × 240 V |
| | | viewing windows |
| 25-way Grid | 256 H × 192 V/25 Windows | 5 × 5 Grid of 256 H × 192 V |
| | | viewing windows |

Table 2 illustrates exemplary stream selection parameters in the form of characteristics of video streams, e.g., such as may be available from video source/s 102 of FIGS. 1-3. As previously described, CVAP 122 may determine such stream selection parameters in step 412 of FIG. 4.

TABLE 2

| | IMAGE | | APPROXIMATE | |
|---|---|---|---|---|
| STREAM NAME | RESOLUTION | FRAME RATE | BIT RATE | |
| 16SIF-15 | 1280 H × 960 V | 15 fps | 20 | Mbps |
| 16SIF-5 | 1280 H × 960 V | 5 fps | 6.7 | Mbps |
| 4SIF-30 | 640 H × 480 V | 30 fps | 3 | Mbps |
| 4SIF-15 | 640 H × 480 V | 15 fps | 1.5 | Mbps |
| SIF-30 | 320 H × 240 V | 30 fps | 750 | Kbps |
| SIF-15 | 320 H × 240 V | 15 fps | 375 | Kbps |
| SIF-5 | 320 H × 240 V | 5 fps | 125 | Kbps |
| QSIF-15 | 160 H × 112 V | 15 fps | 96 | Kbps |

Following is a description of an exemplary state machine logic that may be employed using the information of Tables 1 and 2 to implement video selection methodology according to one exemplary embodiment of the disclosed systems and methods. As previously described, a CVAP 122 may determine client viewing modes listed in Table 1 from internal application-based parameters, configuration information, and/or any other suitable method. A CVAP 122 may also contact and connect with a video source device 102 over network 112 and, using either a well-known protocol (e.g., such as RTSP/SDP (RFCs 2326/2327) or H.245) or other suitable method, the CVAP 122 may discover the available stream types and stream selection parameters (in this case, available video stream characteristics) as listed in Table 2.

Using the following state machine logic, CVAP 122 may then dynamically select video stream/s for display based on a combination of current client viewing mode and determined stream selection parameters. For example, in this case CVAP 122 may dynamically select which video stream/s (i.e., of given SIF resolution and 5, 15 or 30 frame per second frame rate) for display based on current client viewing mode (i.e., Big Mode or single window viewing mode, 4-Way Grid or four window viewing mode, 9-Way Grid or nine window viewing mode, 16-Way Grid or sixteen window viewing mode, or 25-Way Grid or twenty-five window viewing mode in this example) in combination with stream a selection parameter of compute load (i.e., computer processor resource utilization) and/or the use of network-related statistics related to network resource utilization and data reception:

```
Switch ( Viewing_Mode )
{
  Case Single View/Big Mode:
    If ( compute-load is <= %60 AND network-is-not-losing-data )
      Subscribe and display 16SIF-15 stream;
    Else
      Subscribe and display 16SIF-5 stream;
    EndIf;
  Case 4-Way Grid:
    If ( compute-load is <= %80 )
      (Re)connect all active streams to 4SIF-30;
    Else If ( 4SIF-15 is available )
      (Re)connect all active streams to 4SIF-15;
    Else
      (Re)connect all active streams to SIF-30;
    EndIf;
  Case 9-Way Grid:
    If ( compute-load is <= %70 )
      (Re)connect all active streams to SIF-30;
    Else If (compute-load <= %80 )
      (Re)connect all active streams to SIF-15;
    Else
      (Re)connect all active streams to SIF-5;
    EndIf;
  Case 16-way Grid:
    If ( compute-load is <= %70 )
      (Re)connect all active streams to SIF-15;
      /* Total
    Else If (compute-load <= %80 )
      (Re)connect all active streams to SIF-5;
    Else
      (Re)connect all active streams to QSIF-15;
    EndIf;
  Case 25-way Grid:
    (Re)connect all active streams to QSIF-15;
}  // End of Switch logic
```

Whether in multi-window viewing mode or in single window viewing mode, the disclosed systems and methods may be advantageously implemented to dynamically select video stream/s for display based on a combination of current client viewing mode and determined stream selection parameters. For example, in single window viewing mode, video stream selection may be dynamically performed according to the disclosed system and methods upon occurrence of one or more re-sizings of the single viewing window by a user.

It will be understood that the term ‘video stream’ is used herein as a logical term. In this regard, a ‘video stream’ identifies one or more video images, transferred in a logical sequence, that share the same basic attribute, for example, attributes of frame resolution, frame rate, and bit rate. However, it will also be understood that images of a video stream may also share other types of attributes, e.g., a series of video images transferred over the same network connection (‘socket’), a series of video images associated with the same source device or file/track, a series of video images that all share the same timespan, a series of video images that are all associated with the same event or set of events, a series of video images that are all within the same specific timespan from the same video source, etc. In this regard, it is not necessary that there be a direct correlation between a specific network connection or session used to transfer video data and a particular video stream.

In the practice of the disclosed systems and methods, a video source may be configured to provide multiple video streams, and the ability to switch between these video streams in a real-time manner. In this regard, video stream ‘switching’ may be performed in any suitable manner. However, in one embodiment it may be desirable that the a video source be configured to reconfigure, reselect, setup, reconnect, and re-assign video streams in a manner such that there is no detectable disruption of video data at the CVAP. Following are three exemplary manners in which a video source may accomplish video ‘switching’, it being understood that any other suitable methods are also possible.

In one exemplary embodiment, a video source may supply individual video streams on corresponding respective different individual logical network connections (e.g., different TCP/UDP/IP ‘sockets’) that are negotiated between the video source and the CVAP. In one example, Unicast RTSP/RTP protocol may be employed for this purpose. A CVAP may implement a ‘Connect/Disconnect/Reconnect’ method to communicate with a video source to switch between video streams. In this exemplary embodiment, a network connection is equivalent to an individual video stream. A signaling/management/control protocol (e.g., such as RTSP/SDP (RFCs 2326/2327), SIP (RFC 2543), H.225/H.245, etc.) to manage these processes may be necessary in some cases.

In another exemplary embodiment, a single (possibly persistent in one embodiment) network connection (e.g., a single socket) may be enabled to dynamically transfer multiple logically separate video streams. In one example, an HTTP-like or tunneling protocol may employed for this purpose. A CVAP may signal the video source when to change the video stream within the single network connection, using a signaling/management/control protocol (e.g., such as HTTP URL management/URL aliasing, RTSP Interleaved mode, etc.) and the video stream may be changed within the data (packet transport with payload identifier) transferred within the network connection. In such an embodiment, no Connect/Disconnect/Reconnect activity is required.

In yet another exemplary embodiment, various video streams may be distributed across a network on multicast connections (e.g., using multiple multicast sockets) and a CVAP, on its own, may switch to the reception of the available multicast connection/s that supports a desired or selected video stream without any negotiation required with the video source/s. In one example a RTP Multicast protocol may be employed for this purpose.

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed systems and methods may be utilized in various combinations and/or independently. Thus the invention is not limited to only those combinations shown herein, but rather may include other combinations.

What is claimed is:

1. A video selection system, comprising at least one viewing client configured to be coupled to receive at least two video streams over at least one network connection, said viewing client being configured to select at least one of said video streams based at least in part on at least one video stream selection parameter.

2. The system of claim 1, wherein said at least one stream selection parameter comprises at least one dynamic stream selection parameter.

3. The system of claim 2, wherein said at least one dynamic stream selection parameter comprises:
a first dynamic stream selection parameter based on at least one characteristic of a first one of said at least two video streams;
a second dynamic stream selection parameter based on at least one characteristic of a second one of said at least two video streams; and
a third dynamic stream selection parameter based on at least one characteristic of said viewing client or at least one characteristic of said at least one network connection.

4. The system of claim 3, wherein said at least one characteristic of said first one of said at least two video streams comprises at least one of video stream resolution or video stream frame rate; wherein said at least one characteristic of said second one of said at least two video streams comprises at least one of video stream resolution or video stream frame rate; wherein said at least one characteristic of said viewing client component comprises processing resource usage of said viewing client; and wherein said at least one characteristic of said at least one network connection comprises bandwidth usage of said network connection.

5. The system of claim 1, wherein said at least one stream selection parameter comprises at least one static stream selection parameter and at least one dynamic stream selection parameter.

6. The system of claim 5, wherein said at least one static stream selection parameter comprises a static stream selection policy; and wherein said at least one dynamic stream selection parameter comprises:
a first dynamic stream selection parameter based on at least one characteristic of a first one of said at least two video streams;
a second dynamic stream selection parameter based on at least one characteristic of a second one of said at least two video streams; and
a third dynamic stream selection parameter based on at least one characteristic of said viewing client or at least one characteristic of said at least one network connection.

7. The system of claim 6, wherein said static stream selection policy comprises a policy that specifies selected video stream resolutions based on a specified spatial resolution of at least one display window to be provided for display by said viewing client; wherein said at least one characteristic of said first one of said at least two video streams comprises at least one of video stream resolution or video stream frame rate; wherein said at least one characteristic of said second one of said at least two video streams comprises at least one of video stream resolution or video stream frame rate; wherein said at least one characteristic of said viewing client comprises processing resource usage of said viewing client; and wherein said at least one characteristic of said at least one network connection comprises bandwidth usage of said network connection.

8. The system of claim 6, wherein said viewing client is configured to select at least one of said video streams using state machine logic.

9. A video delivery system, comprising at least one video source and said video selection system of claim 1, said at least one video source being coupled to provide said at least two video streams.

10. The video delivery system of claim 9, further comprising at least one video display component coupled to said viewing client; wherein said viewing client is configured to provide said at least one selected video stream to said video display for display.

11. A video delivery system, comprising at least one video source, at least one video access component, and said video selection system of claim 1; wherein said at least one video source is coupled to provide said at least two video streams to said at least one video access component; and wherein said at least one video access component is coupled to provide said at least two video streams to said video selection system of claim 1.

12. The video delivery system of claim 11, further comprising at least one video display component coupled to said viewing client; wherein said viewing client is configured to provide said at least one selected video stream to said video display for display.

13. A video selection system, comprising a viewing client configured to be coupled to receive at least two video streams over at least one network connection, said viewing client being configured to adaptively select at least one of said video streams based at least in part on at least one of current video delivery operating conditions, current specified viewing display modes, or a combination thereof.

14. The system of claim 13, wherein said viewing client is configured to dynamically and adaptively select at least one of said video streams based at least in part on at least one of current video delivery operating conditions, current specified viewing display modes, or a combination thereof; and wherein said current video operating conditions comprise at least one of:
one or more characteristics of said at least two video streams;
one or more operating characteristics of said viewing client;
one or more operating characteristics of said network connection; or
a combination thereof.

15. The system of claim 13, wherein said viewing client is configured to dynamically and adaptively select at least one of said video streams based at least in part on at least one of current video delivery operating conditions, current specified viewing display modes, or a combination thereof; and wherein said current video delivery operating conditions comprise at least one of video stream resolution or video stream frame rate of said at least two video streams, processing resource usage of said viewing client, bandwidth usage of said network connection, or a combination thereof.

16. The system of claim 13, wherein said viewing client is configured to dynamically and adaptively select at least one of said video streams based at least in part on at least one of current video delivery operating conditions, current specified viewing display modes, or a combination thereof; and wherein said viewing client is further configured to dynamically and adaptively select at least one of said video streams based at least in part on a static stream selection policy.

17. The system of claim 16, wherein said static stream selection policy comprises a policy that specifies selected video stream resolutions based on a specified spatial resolution of at least one display window to be provided for display by said viewing client component; and wherein said current video delivery operation conditions comprise a combination of:
video stream resolution or video stream frame rate of said at least two video streams;
processing resource usage of said viewing client; and
bandwidth usage of said network connection.

18. The system of claim 17, wherein said viewing client is configured to select at least one of said video streams using state machine logic.

19. A video delivery system, comprising at least one video source and said video selection system of claim 13, said at least one video source being coupled to provide said at least two video streams.

20. The video delivery system of claim 19, further comprising at least one video display component coupled to said viewing client; wherein said viewing client is configured to provide said at least one selected video stream to said video display component for display.

21. A video delivery system, comprising at least one video source, at least one video access component, and said video selection system of claim 13; wherein said at least one video source is coupled to provide said at least two video streams to said at least one video access component; and wherein said at least one video access component is coupled to provide said at least two video streams to said video selection system of claim 13.

22. The video delivery system of claim 21, further comprising at least one video display component coupled to said viewing client; wherein said viewing client is configured to provide said at least one selected video stream to said video display for display.

23. A method of selecting video streams, comprising selecting at least one video stream from at least two video streams available over at least one network connection; wherein said at least one video stream is selected from said at least two video streams based at least in part on at least one video stream selection parameter.

24. The method of claim 23, wherein said at least one stream selection parameter comprises at least one dynamic stream selection parameter.

25. The method of claim 24, wherein said at least one dynamic stream selection parameter comprises:
a first dynamic stream selection parameter based on at least one characteristic of a first one of said at least two video streams;
a second dynamic stream selection parameter based on at least one characteristic of a second one of said at least two video streams; and
a third dynamic stream selection parameter based on at least one characteristic of a viewing client or at least one characteristic of said at least one network connection.

26. The method of claim 25, wherein said at least one characteristic of said first one of said at least two video streams comprises at least one of video stream resolution or video stream frame rate; wherein said at least one characteristic of said second one of said at least two video streams comprises at least one of video stream resolution or video stream frame rate; wherein said at least one characteristic of said viewing client comprises processing resource usage of said viewing client; and wherein said at least one characteristic of said at least one network connection comprises bandwidth usage of said network connection.

27. The method of claim 23, wherein said at least one stream selection parameter comprises at least one static stream selection parameter and at least one dynamic stream selection parameter.

28. The method of claim 27, wherein said at least one static stream selection parameter comprises a static stream selection policy; and wherein said at least one dynamic stream selection parameter comprises:
a first dynamic stream selection parameter based on at least one characteristic of a first one of said at least two video streams;
a second dynamic stream selection parameter based on at least one characteristic of a second one of said at least two video streams; and
a third dynamic stream selection parameter based on at least one characteristic of a viewing client or at least one characteristic of said at least one network connection.

29. The method of claim 28, wherein said static stream selection policy comprises a policy that specifies selected video stream resolutions based on a specified spatial resolution of at least one display window to be provided for display by said viewing client; wherein said at least one characteristic of said first one of said at least two video streams comprises at least one of video stream resolution or video stream frame rate; wherein said at least one characteristic of said second one of said at least two video streams comprises at least one of video stream resolution or video stream frame rate; wherein said at least one characteristic of said viewing client comprises processing resource usage of said viewing client; and wherein said at least one characteristic of said at least one network connection comprises bandwidth usage of said network connection.

30. The method of claim 28, further comprising selecting said at least one of said video streams using state machine logic.

31. The method of claim 23, further comprising displaying said at least one selected video stream.

32. A method of selecting video streams, comprising adaptively selecting at least one video stream from at least two video streams available over at least one network connection; wherein said at least one video stream is selected from said at least two video streams based at least in part on at least one of current video delivery operating conditions, current specified viewing display modes, or a combination thereof.

33. The method of claim 32, further comprising dynamically and adaptively selecting at least one video stream from at least two video streams available over at least one network connection; and wherein said current video operating conditions comprise at least one of:
one or more characteristics of said at least two video streams;
one or more operating characteristics of a viewing client;
one or more operating characteristics of said network connection; or
a combination thereof.

34. The method of claim 32, further comprising dynamically and adaptively selecting at least one video stream from at least two video streams available over at least one network connection; and wherein said current video delivery operating conditions comprise at least one of video stream resolution or video stream frame rate of said at least two video streams, processing resource usage of a viewing client, bandwidth usage of said network connection, or a combination thereof.

35. The method of claim 32, further comprising dynamically and adaptively selecting at least one video stream from at least two video streams available over at least one network connection; and further comprising dynamically and adaptively selecting at least one of said video streams based at least in part on a static stream selection policy.

36. The method of claim 35, wherein said static stream selection policy comprises a policy that specifies selected video stream resolutions based on a specified spatial resolution of at least one display window to be provided for display by said viewing client component; and wherein said current video delivery operation conditions comprise a combination of:
video stream resolution or video stream frame rate of said at least two video streams;
processing resource usage of a viewing client; and
bandwidth usage of said network connection.

37. The method of claim 36, further comprising selecting at least one of said video streams using state machine logic.

38. The method of claim 32, further comprising dynamically and adaptively selecting at least one video stream from at least two video streams available over at least one network connection; and further comprising displaying said at least one selected video stream.

39. A video delivery system, comprising:
one or more video source components, said one or more video source components being configured to provide at least two video streams;
at least one video display component; and
a viewing client coupled to receive said at least two video streams over at least one network connection, said viewing client being coupled to said video display component;
wherein said viewing client is configured to select at least one of said at least two video streams based at least in part on at least one video stream selection parameter, and to provide said at least one selected video stream to said video display component for display.

40. The system of claim 39, wherein a first one of said at least two video streams has a first combination of resolution and frame rate; wherein a second one of said at least two video streams has a second combination of resolution and frame rate; and wherein said first combination of resolution and frame rate is different than said second combination of resolution and frame rate.

41. The system of claim 39, wherein said at least one stream selection parameter comprises at least one dynamic stream selection parameter.

42. The system of claim 41, wherein said at least one dynamic stream selection parameter comprises:
a first dynamic stream selection parameter based on at least one characteristic of a first one of said at least two video streams;
a second dynamic stream selection parameter based on at least one characteristic of a second one of said at least two video streams; and
a third dynamic stream selection parameter based on at least one characteristic of said viewing client or at least one characteristic of said at least one network connection.

43. The system of claim 42, wherein said at least one characteristic of said first one of said at least two video streams comprises at least one of video stream resolution or video stream frame rate; wherein said at least one characteristic of said second one of said at least two video streams comprises at least one of video stream resolution or video stream frame rate; wherein said at least one characteristic of said viewing client component comprises processing resource usage of said viewing client; and wherein said at least one characteristic of said at least one network connection comprises bandwidth usage of said network connection.

44. The system of claim 39, wherein said at least one stream selection parameter comprises at least one static stream selection parameter and at least one dynamic stream selection parameter.

45. The system of claim 44, wherein said at least one static stream selection parameter comprises a static stream selection policy; and wherein said at least one dynamic stream selection parameter comprises:
a first dynamic stream selection parameter based on at least one characteristic of a first one of said at least two video streams;
a second dynamic stream selection parameter based on at least one characteristic of a second one of said at least two video streams; and
a third dynamic stream selection parameter based on at least one characteristic of said viewing client or at least one characteristic of said at least one network connection.

46. The system of claim 45, wherein said static stream selection policy comprises a policy that specifies selected video stream resolutions based on a specified spatial resolution of at least one display window to be provided for display by said viewing client; wherein said at least one characteristic of said first one of said at least two video streams comprises at least one of video stream resolution or video stream frame rate; wherein said at least one characteristic of said second one of said at least two video streams comprises at least one of video stream resolution or video stream frame rate; wherein said at least one characteristic of said viewing client comprises processing resource usage of said viewing client; and wherein said at least one characteristic of said at least one network connection comprises bandwidth usage of said network connection.

47. The system of claim 45, wherein said viewing client is configured to select at least one of said video streams using state machine logic.

48. A video delivery system, comprising:
at least one video access component coupled to receive at least one video stream from at least one video source component;
at least one video display component; and
a viewing client coupled to receive at least two video streams over at least one network connection, at least one of said at least two video streams received by said viewing client being received from said at least one video access component, and said viewing client being coupled to said video display component;
wherein said viewing client is configured to select at least one of said at least two video streams received by said viewing client based at least in part on at least one video stream selection parameter, and to provide said at least one selected video stream to said video display component for display.

49. The system of claim 48, further comprising said at least one video source component; wherein said at least one video access component is coupled to receive at least one first video stream from at least one video source component; wherein said at least one video access component is configured to provide at least one second video stream based on said at least one first video stream; wherein at least one of said at least two video streams received by said viewing client over said at least one network connection comprises said at least one second video stream; wherein said at least one first video stream has a first combination of resolution and frame rate; wherein said at least one second video stream has a second combination of resolution and frame rate; and wherein said first combination of resolution and frame rate is different than said second combination of resolution and frame rate.

50. The system of claim 48, further comprising said at least one video source component; wherein a first one of said at least two video streams received by said viewing client has a first combination of resolution and frame rate; wherein a second one of said at least two video streams received by said viewing client has a second combination of resolution and frame rate; and wherein said first combination of resolution and frame rate is different than said second combination of resolution and frame rate.

51. The system of claim 48, further comprising said at least one video source component; wherein said at least one stream selection parameter comprises at least one dynamic stream selection parameter.

52. The system of claim 51, wherein said at least one dynamic stream selection parameter comprises:
a first dynamic stream selection parameter based on at least one characteristic of a first one of said at least two video streams received by said viewing client;
a second dynamic stream selection parameter based on at least one characteristic of a second one of said at least two video streams received by said viewing client; and
a third dynamic stream selection parameter based on at least one characteristic of said viewing client or at least one characteristic of said at least one network connection.

53. The system of claim 52, wherein said at least one characteristic of said first one of said at least two video streams received by said viewing client comprises at least one of video stream resolution or video stream frame rate; wherein said at least one characteristic of said second one of said at least two video streams received by said viewing client comprises at least one of video stream resolution or video stream frame rate; wherein said at least one characteristic of said viewing client component comprises processing resource usage of said viewing client; and wherein said at least one characteristic of said at least one network connection comprises bandwidth usage of said network connection.

54. The system of claim 48, further comprising said at least one video source component; wherein said at least one stream selection parameter comprises at least one static stream selection parameter and at least one dynamic stream selection parameter.

55. The system of claim 54, wherein said at least one static stream selection parameter comprises a static stream selection policy; and wherein said at least one dynamic stream selection parameter comprises:
a first dynamic stream selection parameter based on at least one characteristic of a first one of said at least two video streams received by said viewing client;
a second dynamic stream selection parameter based on at least one characteristic of a second one of said at least two video streams received by said viewing client; and
a third dynamic stream selection parameter based on at least one characteristic of said viewing client or at least one characteristic of said at least one network connection.

56. The system of claim 55, wherein said static stream selection policy comprises a policy that specifies selected video stream resolutions based on a specified spatial resolution of at least one display window to be provided for display by said viewing client; wherein said at least one characteristic of said first one of said at least two video streams received by said viewing client comprises at least one of video stream resolution or video stream frame rate; wherein said at least one characteristic of said second one of said at least two video streams received by said viewing client comprises at least one of video stream resolution or video stream frame rate; wherein said at least one characteristic of said viewing client comprises processing resource usage of said viewing client; and wherein said at least one characteristic of said at least one network connection comprises bandwidth usage of said network connection.

57. The system of claim 55, wherein said viewing client is configured to select at least one of said at least two video streams received by said viewing client using state machine logic.

58. A method of delivering video streams, comprising:
providing at least two video streams over at least one network connection;
selecting at least one of said at least two video streams based at least in part on at least one video stream selection parameter; and
displaying said at least one selected video stream.

59. The method of claim 58, wherein a first one of said at least two video streams has a first combination of resolution and frame rate; wherein a second one of said at least two video streams has a second combination of resolution and frame rate; and wherein said first combination of resolution and frame rate is different than said second combination of resolution and frame rate.

60. The method of claim 58, wherein said at least one stream selection parameter comprises at least one dynamic stream selection parameter.

61. The method of claim 60, wherein said at least one dynamic stream selection parameter comprises:
a first dynamic stream selection parameter based on at least one characteristic of a first one of said at least two video streams;
a second dynamic stream selection parameter based on at least one characteristic of a second one of said at least two video streams; and
a third dynamic stream selection parameter based on at least one characteristic of a viewing client or at least one characteristic of said at least one network connection.

62. The method of claim 61, wherein said at least one characteristic of said first one of said at least two video streams comprises at least one of video stream resolution or video stream frame rate; wherein said at least one characteristic of said second one of said at least two video streams comprises at least one of video stream resolution or video stream frame rate; wherein said at least one characteristic of said viewing client component comprises processing resource usage of said viewing client; and wherein said at least one characteristic of said at least one network connection comprises bandwidth usage of said network connection.

63. The method of claim 58, wherein said at least one stream selection parameter comprises at least one static stream selection parameter and at least one dynamic stream selection parameter.

64. The method of claim 63, wherein said at least one static stream selection parameter comprises a static stream selection policy; and wherein said at least one dynamic stream selection parameter comprises:
a first dynamic stream selection parameter based on at least one characteristic of a first one of said at least two video streams;
a second dynamic stream selection parameter based on at least one characteristic of a second one of said at least two video streams; and
a third dynamic stream selection parameter based on at least one characteristic of a viewing client or at least one characteristic of said at least one network connection.

65. The method of claim 64, wherein said static stream selection policy comprises a policy that specifies selected video stream resolutions based on a specified spatial resolution of at least one display window to be provided for display by said viewing client; wherein said at least one characteristic of said first one of said at least two video streams comprises at least one of video stream resolution or video stream frame rate; wherein said at least one characteristic of said second one of said at least two video streams comprises at least one of video stream resolution or video stream frame rate; wherein said at least one characteristic of said viewing client comprises processing resource usage of said viewing client; and wherein said at least one characteristic of said at least one network connection comprises bandwidth usage of said network connection.

66. The method of claim 65, wherein said viewing client is configured to select at least one of said video streams using state machine logic.
